(19) United States
(12) Patent Application Publication
(10) Pub. No.: US 2003/0185994 A1
(43) Pub. Date: Oct. 2, 2003

(54) Coated chain and method for coating chain

(75) Inventor: Won-Cheol Kim, Kyungnam (KR)

Correspondence Address: NOTARO & MICHALOS P.C., Suite 110, 100 Dutch Hill Road, Orangeburg, NY, 10962-2100, US

(73) Assignee: Hwa Sung Gye Jeon Co., Ltd., Masan-City (KR)

(21) Appl. No.: 10/400,720

(22) Filed: Mar. 27, 2003

Related U.S. Application Data
(62) Division of application No. 09/889,340, filed on Jul. 16, 2001, now abandoned.
Application No. 09/889,340 is a 371 of international application No. PCT/KR00/00529, filed on May 25, 2000.

(30) Foreign Application Priority Data
Jul. 28, 1999 (KR) 1999/31762

(51) Int. Cl. B05D 3/02; B05D 1/18

(52) U.S. Cl. 427/435; 427/318; 427/398.1

(57) ABSTRACT

A method for coating a chain comprised of a plurality of rings and connected to one another, including the steps of: preheating the chain at 200° C. for about 1^{˜}2 minutes; dipping the preheated chain with coating liquid mixed with given liquids; heating the dipped chain at approximately 150^{˜}350° C. for 1^{˜}2 minutes; refrigerating the heated chain by the atmosphere temperature; and coating the chain.

### BACKGROUND OF THE INVENTION

1. Field of the Invention

The invention of the invention relates to a chain comprised of a plurality of rings, and more particularly, to a chain which coating of the surface thereof is processed with a fluorescent pigment or general color tone pigment and a method for coating the chain.

2. Description of the Related Art

Usually, a chain is comprised of a plurality of rings having the format of the vast sky and connected to one another, and in reality, is now widespreadly used for various usages in the inside and outside of the country. Meanwhile, since the construction and the usage of the chain is already wide-known technique, the concrete description thereof will be omitted hereinafter.

However, now that the chain is easily eroded upon contacting with the water, the sense of touch of the chain is cool, and the appearance of the chain is coarse, it results in unpleasantness. Also, the chain can not embody its effect in all using places, and specially, the chain used in the guide rail, the mountaineering road, the ship, and the parking zone E/L has the problem in the term of safety.

In the meantime, Korea Laid-Open Utility Model Publication No. 98-59714 discloses chains which form nectilucence or the fluorescent layer at one portion of the crystal comprising the neckpiece or the bracelet.

While the above Utility Model as already filed makes grooves at the crystal including the chain and charges the nectilucent liquid, it can not be applied to the general chain, more concretely, the chain comprised of a plurality of rings having the format of the vast sky. Namely, the grooves can not be formed at the general chain as well as, even if the grooves are formed thereat, it can not solve the above problem.

### SUMMARY OF THE INVENTION

It is therefore an object of the present invention for solving the above problem to provide a chain which coating of the surface thereof is processed with coating liquid made of fluorescent pigment or general color tone pigment and a method for coating the chain.

It is another object of the present invention to provide a chain for improving the touch of the chain composed of a plurality of rings and a method for coating the chain.

It is further object of the present invention to provide a chain distinguishable in the nighttime.

Those and other objects can be achieved according to the present invention with a method for coating a chain comprised of a plurality of rings and connected to one another, including the steps of: preheating the chain at 200° C. for about 1˜2 minutes; dipping the preheated chain with coating liquid mixed with given liquids; heating the dipped chain at approximately 150˜350° C. for 1˜2 minutes; refrigerating the heated chain by the atmosphere temperature; and, coating the chain.

More preferably, the coating liquid is made by one another, mixing poly vinyl chloride of 100 weight, plasticizer of 0.5˜2.0 weight, charging liquid of 0.05˜0.1 weight, stabilizer of 0.01˜1.0 weight, and fluorescent pigment or general color tone pigment of 0.05˜3.0 weight.

### DETAILED DESCRIPTION OF THE PREFERRED EMBODIMENTS

Hereinafter, a preferred embodiment of the present invention will be in detail explained. Further, in the following description, coating the chain according to the present invention are set forth to provide a more thorough understanding of the present invention. It is noted that a detailed description of known functions and constructions unnecessarily obscuring the subject matter of the present invention has been omitted in the following description for clarity.

Most of all, the present invention coats he surface of the chain made of the metal, that is, chain composed a plurality of rings having the format of the vast sky and connected to the one another. Concretely, after the above-mentioned chain puts in a preheater and is preheated for 1˜2 minutes at approximately 150˜350° C., the preheated chain is dipped with the coating liquid as the main part of the present invention.

Meanwhile, the coating liquid is made of resin as the main part, the plasticizer, the charging liquid, the stabilizer, and the fluorescent pigment or the general color tone pigment. That is, the coating liquid is made by one another, mixing poly vinyl chloride of 100 weight, the plasticizer of 0.5˜2.0 weight, the charging liquid of 0.05˜0.1 weight, the stabilizer of 0.01˜1.0 weight, and the fluorescent pigment or the general color tone pigment of 0.05 ˜3.0 weight.

Herein, any one of three liquids is selected and used as the above plasticizer, and three liquids correspond to D-2 hexyi phthalate(hereinafter, referred to as “DOP”), D-butyl phthalate(hereinafter, referred to as “DBP”), and D-iso phthalate(hereinafter, referred to as “DOA”).

Meantimes, carbonic acid calcium is used as the charging liquid and the stabilizer si mostly made with mixing liquid BC 103 with barium straight or karium zinc having the format of powder.

Further, the fluorescent pigment or the general color tone pigment is used as the pigment. At this point, the fluorescent pigment is tinged with the yellow, the orange, or the green an has the physical characteristics of AV partile size: 5N, Light Fastness: 3, Heat Stability: 110˜230F, Oil Absorption: 30˜35, and Moisture Content: 3.5. Furthermore, the above-mentioned general color tone pigment is tinged with general color tone.

Hereinafter, while the detailed description is given according to the preferred embodiment of the present invention, the present invention is not defined in the embodiments as will be stated hereinafter.

[Embodiment 1]

The coating liquid is made by one another, mixing the poly vinyl chloride of 100 weight, the DOP of 1.0 weight, the carbonic acid calcium of 0.08 weight, the barium straight of 0.07 weight, and the fluorescent pigment of 1.0 weight, preferably, the fluorescent pigment with the above-stated physical characteristics.

Next, after preheating the chain made of the metal at 200° C. for about 1 minute, dipping the chain with the coating liquid, heating the dipped chain for 1 minute and 30 seconds at approximately 250° C., the above chain puts in the blower and is refrigerated by the atmosphere temperature, so that the chain forming the fluorescent coating layer can be made thereat.

[Embodiment 2]

The coating liquid is made by one another, mixing the poly vinyl chloride of 100 weight, the DOP of 1.5 weight, the carbonic acid calcium of 0.1 weight, the barium straight of 0.05 weight, and the general color tone pigment of, 3.0 weight, preferably, the pigment tinged with the yellow.

Next, after preheating the chain made of the metal at 320° C. for about 2 minutes, dipping the chain with the coating liquid, heating the dipped chain for 2 minutes at approximately 250° C., the above chain puts in the blower and is refrigerated by the atmosphere temperature. Thus, the chain forming the yellow coating layer is made.

[Embodiment 3]

The coating liquid is made by one another, mixing the poly vinyl chloride of 100 weight, the DOA of 2.0 weight, the carbonic acid calcium of 0.1 weight, the karium zinc of 0.1 weight, and the fluorescent pigment of 1.5 weight, preferably, the fluorescent pigment with the above-stated physical characteristics.

Next, after preheating the chain made of the metal at 320° C. for about 2 minutes, dipping the chain with the coating liquid, heating the dipped chain for 2 minutes at approximately 250° C., the above chain puts in the blower and is refrigerated by the atmosphere temperature, so that the chain coated with the fluorescence can be made.

[Embodiment 4]

The coating liquid is made by one another, mixing the poly vinyl chloride of 100 weight, the DOP of 2.0 weight, the carbonic acid calcium of 0.1 weight, the karium zinc of 0.1 weight, and the fluorescent pigment of 3.0 weight, preferably, the fluorescent pigment with the above-stated physical characteristics.

Next, after preheating the chain made of the metal at 320° C. for about 2 minutes, dipping the chain with the coating liquid, heating the dipped chain for 2 minutes at approximately 250° C., the above chain puts in the blower and is refrigerated by the atmosphere temperature, so that the chain coated with fluorescence can be made thereat.

As amy be apparent from the foregoing, the present invention provides the chain which is not eroded even if the chain exposes-to the water for the long time because of coating the surface of the chain, is excellent in the aesthetic sense, and has smooth touch sense. Further, the chain has no twisting and no noise as well as can prevent the leakage of electricity. Furthermore, it has the advantage of preventing the sliding.

Especially, the present invention can be used to be stable rather than the conventional chain upon using in the guide rail, the mountaineering road, the ship, the parking zone E/L, advantageously. Likewise, by coating the surface of the chain with the fluorescence, it is distinguishable in the nighttime, prevents the accident from being generated, and can be used in the interior decoration and all kinds of interiors.

While there have been illustrated and described what are considered to be preferred embodiments of the present invention, it will be understood by those shill in the art that various changes and modifications may be made, and equivalents may: be substituted for elements thereof without departing from the true scope of the present invention. In addition, many modifications may be made to adapt a particular situation to the teaching of the present invention without departing from the central scope thereof. Therefore, it is intended that the present invention not be limited to the particular embodiments disclosed as the best mode contemplated for carrying out the present invention, but that the present invention includes all embodiments falling within the scope of the appended claims.

What it claimed is:

1. A method for coating a chain comprised of a plurality of rings and connected to one another, comprising the steps of:
preheating said chain at 200° C. for about 1˜2 minutes;
dipping said preheated chain with coating liquid mixed with given liquids;
heating said dipped chain at approximately 150˜350° C. for 1˜2 minutes;
refrigerating said heated chain by the atmosphere temperature; and,
coating the chain.

2. The method as recited in claim 1, wherein said coating liquid is made by one another, mixing poly vinyl chloride of 100 weight, plasticizer of 0.5˜2.0 weight, charging liquid of 0.05˜0.1 weight, stabilizer of 0.01˜1.0 weight, and fluorescent pigment or the general color tone pigment of 0.05˜3.0 weight.

3. The method as recited in claim 2, wherein any one of D-2 hexyi phthalate, D-butyl phthalate, and D-iso phthalate is selected and used as said plasticizer.

4 The method as recited in claim 2, wherein said charging liquid corresponds to carbonic acid calcium.

5. The method as recited in claim 2, wherein said stabilizer is made with mixing liquid BC 103 with barium straight or karium zinc.

6. The method as recited in claim 2, wherein said pigment corresponds to fluorescent pigment or general color tone pigment.
